(19) United States
(12) Patent Application Publication
(10) Pub. No.: US 2002/0110047 A1
(43) Pub. Date: Aug. 15, 2002

(54) Mixing element for a fluid guided in a pipe and pipe having at least one mixing element disposed therein

(76) Inventors: Rolf Bruck, Bergisch Gladbach (DE); Katrin Schaper, Troisdorf (DE); Jan Hodgson, Neunkirchen-Seelscheid (DE)

Correspondence Address: LERNER AND GREENBERG, P.A., Post Office Box 2480, Hollywood, FL, 33022-2480, US

(21) Appl. No.: 10/078,147

(22) Filed: Feb. 19, 2002

Related U.S. Application Data
(63) Continuation of application No. PCT/EP00/07831, filed on Aug. 11, 2000.

(30) Foreign Application Priority Data
Aug. 17, 1999 (DE) 199 38 840.7

(51) Int. Cl. B01F 5/06

(52) U.S. Cl. 366/340

(57) ABSTRACT

A mixing element is provided for a fluid guided in a pipe, especially an exhaust pipe of an internal combustion engine. Parts of an outer flow adjacent an inner surface of the pipe are guided inwardly by an outer guide surface and parts of an inner flow are guided outwardly by an inner guide surface, at the same time and in an approximately common plane. The use of the entire inner surface of the pipe for the purpose of cooling is preferably guaranteed by at least one opening provided in the outer guide surface. A simple measure is thus provided for obtaining a homogenous temperature distribution and good cooling of a fluid guided in a pipe. The mixing element is especially distinguished by its compact construction. A pipe having at least one mixing element disposed therein is also provided.

### CROSS-REFERENCE TO RELATED APPLICATION

This application is a continuation of copending International Application No. PCT/EP00/07831, filed Aug. 11, 2000, which designated the United States.

### BACKGROUND OF THE INVENTION

Field of the Invention

The present invention relates to a mixing element for a fluid guided in a pipe and to a pipe, in particular an exhaust pipe of a motor vehicle, in which at least one such mixing element is installed.

Hot fluids which are guided in pipes, for example exhaust gas from an internal-combustion engine, and are fed to a device, for example a three-way catalytic converter or an NOₓ storage device, have at least one outer flow which is cooled by the outer surface of the pipe, and therefore have an inhomogeneous temperature distribution as seen over the flow cross section.

It is known to place mixing elements in a pipe in order to make inhomogeneous temperature distributions more even. The mixing elements, as seen in a cross-sectional plane of the pipe, either “peel off” parts of the cooler outer flow from the inner surface of the pipe and divert them toward the inside (also referred to below as an outer guide surface) or divert parts of the hotter inner flow toward the outside (also referred to below as an inner guide surface). The mixing elements are inclined with respect to a main flow direction. Therefore, and due to their configuration in series, a pair of known mixing elements requires a relatively long flow path in order to effect intimate mixing.

In many applications, it is also desirable for the flow to be cooled as effectively as possible through heat exchange with the environment. In that case, the outer guide surfaces in particular have the drawback that scarcely any fluid flows onto a considerable part of the inner surface of the pipe in a flow shadow behind the outer guide surfaces, and consequently that part of the inner surface makes no contribution to the heat exchange which is desired in most applications. With regard to cooling, that virtually wipes out the benefit which is otherwise brought by the intimate mixing of the inner and outer flows.

### SUMMARY OF THE INVENTION

It is accordingly an object of the invention to provide a mixing element for a fluid guided in a pipe and a pipe having at least one mixing element disposed therein, which overcome the hereinafore-mentioned disadvantages of the heretofore-known devices of this general type, in which the mixing element ensures that substantially an entire inner surface of the pipe is used for cooling purposes, in which the fluid, after flowing through the mixing element, has a temperature distribution that is as uniform as possible over a flow cross section in order, for example, to avoid thermally induced local damage to a downstream device or premature aging and in which the mixing element has the possibility of automatic production and a compact structure.

With the foregoing and other objects in view there is provided, in accordance with the invention, a mixing element for a fluid guided in a pipe, the pipe having an inner surface and a cross-sectional plane, and the fluid having an inner flow and having an outer flow adjacent the inner surface of the pipe. The mixing element comprises at least one outer guide surface for inwardly diverting parts of the outer flow and at least one inner guide surface for outwardly diverting parts of the inner flow. The at least one outer guide surface and the at least one inner guide surface are disposed at the same time in the cross-sectional plane of the pipe. Only the at least one outer guide surface bears against the inner surface of the pipe.

As a result, hotter and cooler flows are advantageously intimately mixed with one another in such a way that the overall flow has a temperature distribution which is as homogeneous as possible, and thermally induced damage to a downstream device is avoided. A further advantage is that the mixing element according to the invention requires a considerably shorter flow path to achieve intimate mixing of the outer and inner flows of a fluid than the known mixing elements disposed in series as described in the introduction.

In accordance with another feature of the invention, in order to minimize pressure losses in the fluid, the outer and inner guide surfaces are inclined with respect to the main flow direction. An inclination at an angle of approximately 30° to 60°, in particular at an angle of approximately 45°, with respect to the main flow direction has proven advantageous for the outer guide surface, and an inclination at an angle of approximately 30° to 60°, in particular at an angle of approximately 45°, with respect to the main flow direction has likewise proven advantageous for the inner guide surface. The greater the inclination with respect to the main flow direction, the greater the pressure loss but also the more intimate the mixing becomes. Therefore, the angles of inclination of the guide surfaces can be adapted to the particular flow conditions. They may also differ between the inner and outer guide surfaces, in particular if the overall surface areas of the inner and outer guide surfaces are also different.

In accordance with a further feature of the invention, in order to enable the mixing element to be produced in a single piece, the outer and inner guide surfaces are held on a common holding frame.

In accordance with an added feature of the invention, for this purpose, the holding frame has an at least quadrilateral structure, preferably an at least hexagonal structure, or is constructed in the form of any other polygon with an even number of sides.

In accordance with an additional feature of the invention, in order to make the mixing more uniform, the outer and inner guide surfaces are disposed alternately over the periphery of the holding frame. The surface area of an outer guide surface preferably approximately corresponds to the surface area of an inner guide surface.

In accordance with yet another feature of the invention, the outer guide surface is at least partially matched to the contour of the inner surface of the pipe. In this way, parts of an edge flow are also advantageously “peeled off” the inner surface of the pipe and diverted toward the inside.

In accordance with yet a further feature of the invention, in order to improve heat exchange between the fluid and an outer wall surface of the pipe, the outer guide surface has at least one opening, through which part of the outer flow flows onward. As a result, even that part of the pipe surface which lies directly behind an outer guide surface can still contribute to the heat exchange. The size of the opening should preferably amount to approximately 20 to 40% of the area of the outer guide surface.

In accordance with yet an added feature of the invention, the opening is constructed as a segment of a circle which opens out toward the inner surface of the pipe. In this way, the utilization of the entire pipe surface for cooling is advantageously substantially ensured. This segment of a circle may be completely cut out. However, it is particularly expedient if the segment which is used to form the opening is not cut off completely, but rather is simply bent outward in the form of a tab that is connected to the mixing element, where it can be used to secure the element to the inner surface of the pipe.

In accordance with yet an additional feature of the invention, as an alternative or in addition, the inner flow which is diverted from the inside toward the outside is additionally made turbulent in the peripheral direction, so that hot flows are once again diverted directly from the inside into the flow shadow behind the outer guide surfaces. Therefore, it is proposed for the inner guide surfaces to be constructed as swirl blades.

In accordance with again another feature of the invention, the mixing element is connected by joining, in particular welding or soldering, to the pipe at the outer guide surfaces or the tabs which have been bent outward from these surfaces.

In accordance with again a further feature of the invention, the mixing element is produced in a single piece by being stamped out of a sheet-metal part or cut by using a laser, which advantageously allows inexpensive automated production.

In accordance with again an added feature of the invention, the mixing element is at least partly coated. Coating the mixing element has the advantage of ensuring that the mixing element is able to withstand thermal and dynamic loads which occur over a very long period. Furthermore, by way of example, a partial coating makes it easier to form a joined connection between the mixing element and the pipe.

With the objects of the invention in view, there is also provided a pipe, in particular an exhaust pipe of a motor vehicle, comprising at least one of the mixing elements according to the invention, disposed in the pipe.

As compared to known pipes with mixing elements disposed in series, the configuration according to the invention has at least the advantages of the temperature distribution in the fluid being as homogeneous as possible after the inner and outer flows have been mixed and of a low axial space requirement. These are due to the reduced flow path required by the mixing element according to the invention.

In accordance with a concomitant feature of the invention, the degree of mixing can advantageously be increased further if a second mixing element is disposed in the pipe downstream of the first mixing element, as seen in the main direction of flow. This is done in such a way that the inner and outer guide surfaces of this second mixing element are offset with respect to the inner and outer guide surfaces of the first mixing element. With regard to the flow line of an imaginary steady-state flow, this would mean that parts, for example of the outer flow, would be diverted toward the inside by the first mixing element and would then be diverted toward the outside again by the downstream second mixing element.

Other features which are considered as characteristic for the invention are set forth in the appended claims.

Although the invention is illustrated and described herein as embodied in a mixing element for a fluid guided in a pipe and a pipe having at least one mixing element disposed therein, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a mixing element according to the invention which is fitted in an exhaust pipe of an internal-combustion engine;

FIG. 2 is a front-elevational view of the mixing element according to the invention shown in FIG. 1;

FIG. 3 is a developed view of the mixing element according to the invention shown in FIGS. 1 and 2;

FIG. 4 is a fragmentary, front-elevational view of an inner guide surface, which is constructed as a swirl blade, of the mixing element according to the invention; and

FIG. 5 is a longitudinal, axial-sectional view and partly side-elevational view, of a pipe with two mixing elements according to the invention in series.

### DESCRIPTION OF THE PREFERRED EMBODIMENTS

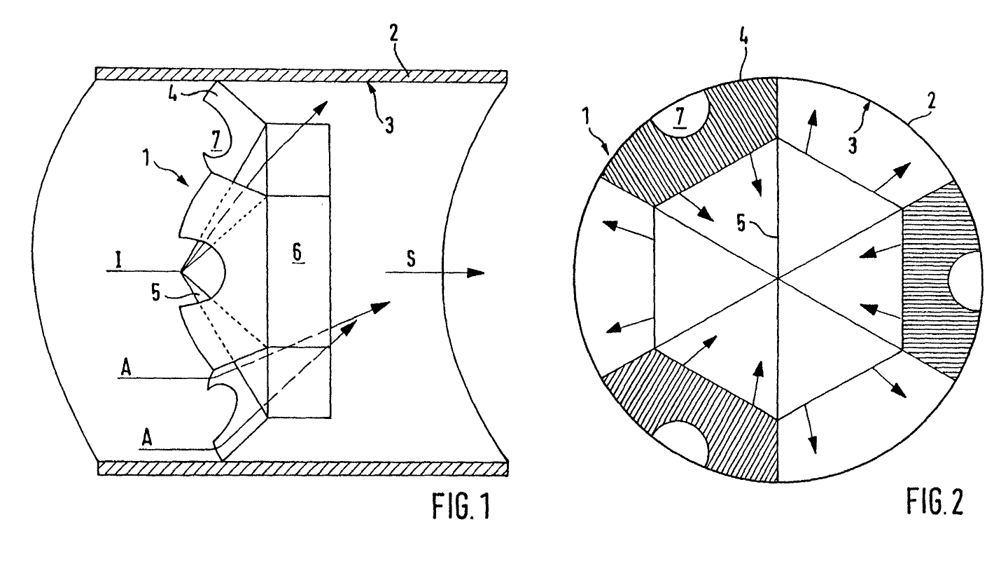

Referring now in detail to the figures of the drawings, further advantages and features of the present invention will now be explained in more detail on the basis of an exemplary embodiment that is used in the automotive industry, but to which the invention is not restricted. Initially regarding FIG. 1, in particular, there is seen a side view of a mixing element 1 according to the invention which is fitted in a pipe 2, for example an exhaust pipe of a non-illustrated internal-combustion engine. Exhaust gas passes from the non-illustrated internal-combustion engine into the exhaust pipe 2 in which the mixing element 1 is disposed. The exhaust gas travels in such a way that, approximately in one plane, at the same time, parts of an outer flow A which is adjacent an inner surface 3 of the pipe 2 are diverted toward the inside and parts of an inner flow I are diverted toward the outside.

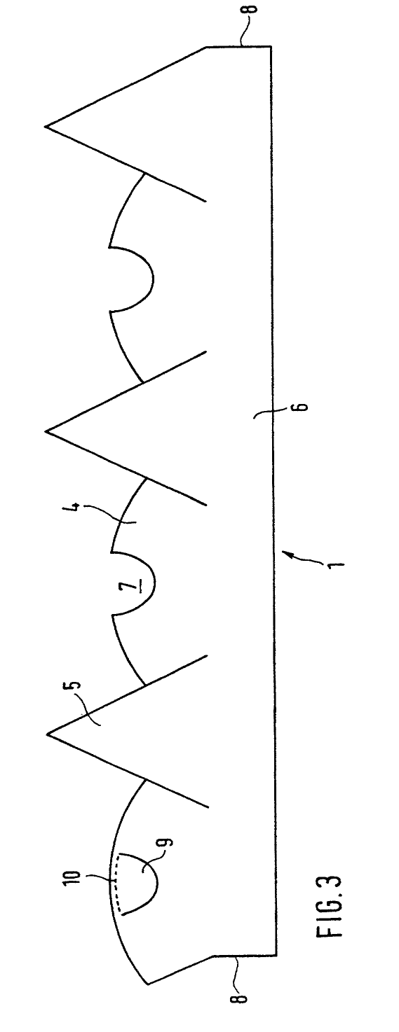

For this purpose, the mixing element 1 according to the exemplary embodiment in each case has three outer guide surfaces 4 and three inner guide surfaces 5. As can be seen in particular from FIGS. 2 and 3, the outer guide surfaces 4 are similar to a trapezoid while the inner guide surfaces 5 are triangular in shape. The outer guide surfaces 4 are used to divert the outer flows A toward the inside, whereas the inner guide surfaces 5 are used to divert the inner flows I toward the outside. In particular, in order to minimize pressure losses in the fluid, the outer guide surfaces 4 and the inner guide surfaces 5 are inclined with respect to a main flow direction S. In the case of the mixing element 1 according to the exemplary embodiment, this inclination amounts to approximately 45° relative to the main flow direction S for the outer guide surface 4 and to approximately 60° relative to the main flow direction S for the inner guide surface 5.

The outer guide surfaces 4 and the inner guide surfaces 5 are held on a common holding frame 6, which preferably has a hexagonal structure in the mixing element 1 according to the exemplary embodiment.

The outer guide surfaces 4 and the inner guide surfaces 5 are disposed alternately over the periphery of the holding frame 6 which lies completely inside the flow cross section and runs substantially parallel to the main flow direction S, in a manner which is favorable for the flow. The sum of the surface areas of the outer guide surfaces 4 preferably approximately corresponds to the sum of the surface areas of the inner guide surfaces 5. Therefore, advantageously, the outer flows A are to be guided toward the inside and the inner flows I are to be guided toward the outside in approximately equal proportions.

As can be seen in particular from FIGS. 2 or 3, in each case the longest side of the trapezoid-like outer guide surfaces 4 is at least partially matched to the contour of the inner surface 3 of the exhaust pipe 2. This, by way of example, advantageously allows the mixing elements 1 to be connected to the exhaust pipe 2 by joining at the outer guide surfaces 4.

Moreover, the outer guide surfaces 4 preferably have at least one opening 7, through which a part of the outer flow flows onward. In the case of the mixing element 1 according to the exemplary embodiment, the opening 7 is constructed as an approximately semicircular segment of a circle which opens out toward the inner surface 3 of the pipe 2. As an alternative or in addition, an outer guide surface 4 may have non-illustrated passage bores through which parts of the outer flow can likewise flow onward. As indicated in FIG. 3, the segment 9 of the circle which is to be removed in order to form the opening 7 may also be incompletely separated from the guide surface 4 and may be bent outward along a bending line 10. This once again forms the desired opening 7, but also allows the segment 9 of the circle which has been bent outward to form a securing tab that bears substantially against the inner surface 3 of the pipe 2 and can be connected to the pipe by joining either over an area or at points. In many cases, this type of connection can be produced more successfully than a connection between the edge of the outer guide surfaces 4 and the pipe 2.

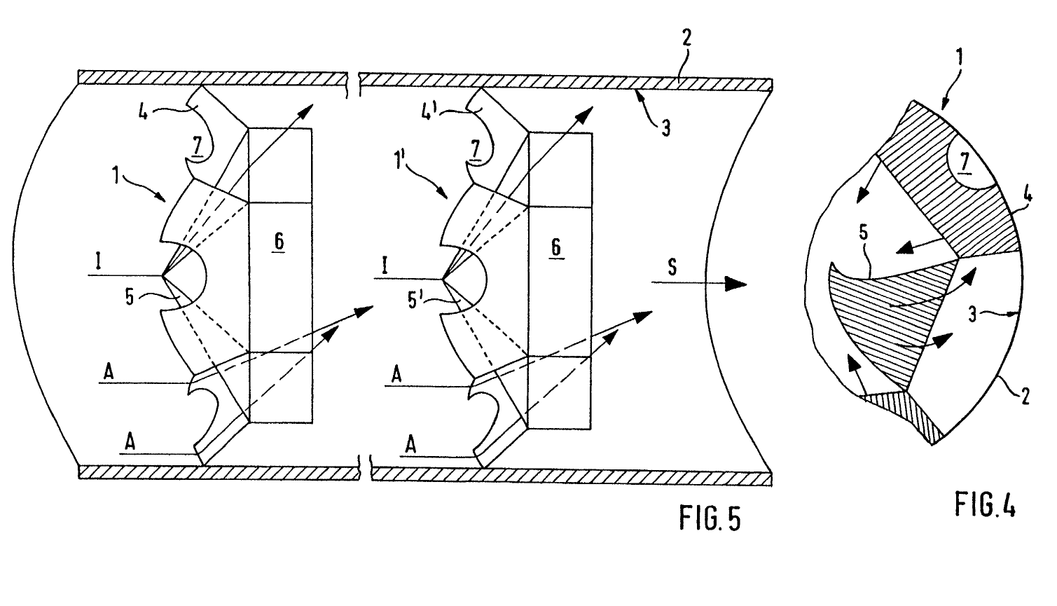

It is particularly expedient if, as an alternative or in addition to the opening 7, the inner flow I which is diverted from the inside toward the outside is additionally made turbulent in the peripheral direction. This is done so that the hot flow I is once again diverted directly from the inside into a flow shadow behind the outer guide surfaces 4. Therefore, it is advantageous if the inner guide surfaces 5 are constructed as what are known as swirl blades, as is diagrammatically illustrated in FIG. 4.

The mixing element 1 according to the exemplary embodiment of the invention can advantageously be produced in a single piece by punching from a sheet-metal part or cutting by laser. A corresponding developed view of the mixing element according to the invention is diagrammatically depicted in FIG. 3.

However, depending on the particular fluid and application, for example hot-water applications, the mixing element may also be produced from other materials, in particular from correspondingly suitable plastics. Manufacturing techniques which are employed include cutting or punching and deformation, in particular thermoforming, injection molding and similar processes.

If the starting material of the mixing element 1 is sheet metal or the like, the stamping or laser cutting of the basic shape of the mixing element 1 is initially carried out, as is diagrammatically illustrated in developed form in FIG. 3. After the stamping or laser cutting, first of all the outer guide surfaces 4 or inner guide surfaces 5 can be bent forward or away, using known deformation techniques, in particular suitable presses, until the desired inclination is reached. Then, the polygonal shape of the holding frame 6 can be formed, which ultimately requires a joining connection, for example welding, only on its abutting sides 8.

Mixing elements 1 according to the invention which can be mass-produced at low cost in this way are preferentially suitable for installation in an exhaust pipe 2 of a motor vehicle. The mixing elements 1 are disposed, in particular, upstream of a honeycomb body, especially a honeycomb body which is coated with catalytically active material and/or material that acts as an adsorber. Pipes according to the invention with one or more mixing elements 1 advantageously achieve a greater cooling action in combination with lower pressure losses, as compared to pipes with a honeycomb body which is installed initially and which guides the exhaust gas in a laminar flow, in particular substantially without heat exchange from the outside toward the inside and vice versa, over a long distance.

As is shown in FIG. 5, a second mixing element 1′ may be disposed in the exhaust pipe 2 downstream of the first mixing element 1, as seen in the main flow direction S. In this case, it has proved to be advantageous for the second mixing element 1′ to be disposed in such a way that its outer guide surfaces 5′ and its inner guide surfaces 4′ are offset with respect to the outer guide surfaces 5 and inner guide surfaces 4 of the first mixing element 1.

The teaching according to the invention is not restricted to the field of exhaust-gas technology which is presented in the exemplary embodiment. Rather, mixing elements 1, 1′ according to the invention can be used wherever fluids which are guided in a pipe 2 are to be cooled or heated uniformly and/or are to have a temperature distribution which is as homogeneous as possible, in particular in order to avoid thermally-induced local damage to a downstream device, in particular an NOₓ storage device.

We claim:

1. A mixing element for a fluid guided in a pipe, the pipe having an inner surface and a cross-sectional plane, and the fluid having an inner flow and having an outer flow adjacent the inner surface of the pipe, the mixing element comprising:
at least one outer guide surface for inwardly diverting parts of the outer flow and at least one inner guide surface for outwardly diverting parts of the inner flow;
said at least one outer guide surface and said at least one inner guide surface disposed together in the cross-sectional plane of the pipe; and
only said at least one outer guide surface bearing against the inner surface of the pipe.

2. The mixing element according to claim 1, wherein the pipe defines a main flow direction, and said at least one outer guide surface is inclined at an angle of 30° to 60° relative to the main flow direction.

3. The mixing element according to claim 1, wherein the pipe defines a main flow direction, and said at least one outer guide surface is inclined at an angle of approximately 45° relative to the main flow direction.

4. The mixing element according to claim 1, wherein the pipe defines a main flow direction, and said at least one inner guide surface is inclined at an angle of 30° to 60° relative to the main flow direction.

5. The mixing element according to claim 1, wherein the pipe defines a main flow direction, and said at least one inner guide surface is inclined at an angle of approximately 45° relative to the main flow direction.

6. The mixing element according to claim 1, including a common holding frame on which said at least one outer guide surface and said at least one inner guide surface are held.

7. The mixing element according to claim 6, wherein said holding frame has a shape selected from the group consisting of a polygon with four sides, a hexagon and another polygon with an even number of sides.

8. The mixing element according to claim 6, wherein said holding frame has a periphery, and said at least one outer guide surface and said at least one inner guide surface are disposed alternately over said periphery of said holding frame.

9. The mixing element according to claim 1, wherein each of said at least one outer guide surfaces has a surface area approximately corresponding to a surface area of each of said at least one inner guide surfaces.

10. The mixing element according to claim 1, wherein the inner surface of the pipe has a contour at least partially matched by said at least one outer guide surface.

11. The mixing element according to claim 1, wherein said at least one outer guide surface has at least one opening formed therein through which a part of the outer flow flows onward.

12. The mixing element according to claim 11, wherein said opening is a segment of a circle opening out toward the inner surface of the pipe.

13. The mixing element according to claim 1, wherein said at least one inner guide surface is a swirl blade for causing the inner flow diverted from the inside toward the outside to become turbulent in peripheral direction.

14. The mixing element according to claim 1, wherein said at least one outer guide surface is connected to the pipe by a joint selected from the group consisting of a welded joint and soldered joint.

15. The mixing element according to claim 6, wherein said frame, said at least one outer guide surface and said at least one inner guide surface are formed in a single piece by a process selected from the group consisting of laser-cutting and punching-out of a sheet-metal part.

16. The mixing element according to claim 1, wherein said frame, said at least one outer guide surface and said at least one inner guide surface are at least partially coated.

17. A pipe, comprising:
an interior defining an inner surface and a cross-sectional plane; and
at least one mixing element disposed in said interior for guiding a fluid having an inner flow and having an outer flow adjacent said inner surface;
said at least one mixing element having at least one outer guide surface for inwardly diverting parts of the outer flow and at least one inner guide surface for outwardly diverting parts of the inner flow, said at least one outer guide surface and said at least one inner guide surface disposed together in said cross-sectional plane, and only said at least one outer guide surface bearing against said inner surface.

18. The pipe according to claim 17, wherein said interior defines a main flow direction, said at least one mixing element includes at least a first mixing element disposed upstream of a second mixing element in said main flow direction, and said at least one inner guide surface and said at least one outer guide surface of said second mixing element are offset relative to said at least one inner guide surface and said at least one outer guide surface of said first mixing element.

19. A motor vehicle exhaust pipe, comprising:
an interior defining an inner surface and a cross-sectional plane; and
at least one mixing element disposed in said interior for guiding exhaust gas having an inner flow and having an outer flow adjacent said inner surface;
said at least one mixing element having at least one outer guide surface for inwardly diverting parts of the outer flow and at least one inner guide surface for outwardly diverting parts of the inner flow, said at least one outer guide surface and said at least one inner guide surface disposed together in said cross-sectional plane, and only said at least one outer guide surface bearing against said inner surface.

20. The pipe according to claim 19, wherein said interior defines a main flow direction, said at least one mixing element includes at least a first mixing element disposed upstream of a second mixing element in said main flow direction, and said at least one inner guide surface and said at least one outer guide surface of said second mixing element are offset relative to said at least one inner guide surface and said at least one outer guide surface of said first mixing element.
